(19) United States
(12) Patent Application Publication
(10) Pub. No.: US 2021/0232853 A1
(43) Pub. Date: Jul. 29, 2021

(54) Object Recognition Method and Terminal Device

(71) Applicant: Huawei Technologies Co., Ltd., Shenzhen (CN)

(72) Inventors: Renzhi Yang, Shanghai (CN); Jiyong Jiang, Shanghai (CN); Teng Zhang, Shanghai (CN); Rui Yan, Shanghai (CN); Dongjian Yu, Shanghai (CN)

(21) Appl. No.: 17/231,352

(22) Filed: Apr. 15, 2021

Related U.S. Application Data
(63) Continuation of application No. PCT/CN2018/110525, filed on Oct. 16, 2018.

(51) Int. Cl. G06K 9/62; G06K 9/00

(52) U.S. Cl. CPC G06K 9/6215; G06K 9/00288; G06K 9/6202

(57) ABSTRACT

An object recognition method, implemented by a terminal device, includes recognizing a first target object in a first frame of image, recognizing a second target object in a second frame of image adjacent to the first frame of image, and if a similarity between the first target object and the second target object is greater than a preset similarity, and a moving speed is less than a preset speed, determining that the first target object and the second target object are a same object.

### CROSS-REFERENCE TO RELATED APPLICATIONS

This application is a continuation of International Patent Application No. PCT/CN2018/110525 filed on Oct. 16, 2018, the disclosure of which is hereby incorporated by reference in its entirety.

### TECHNICAL FIELD

This disclosure relates to the field of terminal technologies, and in particular, to an object recognition method and a terminal device.

### BACKGROUND

With development of terminal technologies, an object recognition technology is applied to increasingly more terminal devices. A mobile phone is used as an example. The mobile phone may collect an image of an object (for example, a face), and recognize an object in the image.

In the conventional technology, an object recognition technology can be used to recognize only an object that is in a relatively fixed form. In real life, forms of many objects, such as a cat and a dog, may change. When a terminal device recognizes that a frame of image includes a cat (for example, the cat is in a standing state), if a next frame of image still includes the cat, but a form of the cat changes (for example, the cat is in a lying state), the terminal device may fail to recognize the cat included in the next frame of image, or may perform incorrect recognition (for example, an animal may be recognized as a dog because the animal has a similar posture when the animal lies).

It can be learned that in the conventional technology, accuracy of recognizing an object whose form can change is relatively low.

### SUMMARY

This disclosure provides an object recognition method and a terminal device, to improve accuracy of recognizing an object whose form can change.

According to a first aspect, an embodiment provides an object recognition method. The method may be performed by a terminal device. The method includes the terminal device recognizes a first target object in a first frame of image. The terminal device recognizes a second target object in a second frame of image adjacent to the first frame of image. If a similarity between the first target object and the second target object is greater than a preset similarity, and a moving speed is less than a preset speed, the terminal device determines that the first target object and the second target object are a same object.

In this embodiment, the terminal device may recognize whether objects in two frames of images, for example, adjacent frames of images, are a same object, to help improve object recognition accuracy.

In a possible design, that the terminal device recognizes a first target object in a first frame of image includes the terminal device obtains first feature information in the first frame of image. The terminal device searches, through matching, a prestored object matching template for second feature information that matches the first feature information, where the object matching template includes a correspondence between an object and feature information. The terminal device determines that an object corresponding to the second feature information in the object matching template is the first target object. That the similarity between the first target object and the second target object is greater than the preset similarity includes the first target object and the second target object belong to a same object type.

In this embodiment, after determining that target objects in two frames of images, for example, adjacent frames of images, belong to a same object type, the terminal device may further determine whether the target objects are a same object, to help improve object recognition accuracy.

In a possible design, the moving speed is used to indicate a ratio of a displacement vector to a time, the displacement vector is a displacement from a first pixel of the first target object to a second pixel of the second target object, and the time is used to indicate a time interval at which the terminal device collects the first frame of image and the second frame of image, and the second pixel is a pixel that is determined by the terminal device according to a matching algorithm and that matches the first pixel.

In this embodiment, the terminal device determines a speed of moving between target objects based on locations of pixels of the target objects in adjacent frames of images and a time interval for collecting the images. If the speed is relatively low, the target objects in the adjacent frames of images are the same object. In this way, this helps improve object recognition accuracy.

In a possible design, that the moving speed is less than the preset speed includes a rate of the moving speed is less than a preset rate, and/or an included angle between a direction of the moving speed and a preset direction is less than a preset angle, where the preset direction is a movement direction of from the third pixel to the first pixel, and the third pixel is a pixel that is determined by the terminal device in a previous frame of image of the first frame of image according to the matching algorithm and that matches the first pixel.

In this embodiment, the terminal device may determine, when speeds and directions of target objects in adjacent frames of images meet a condition, that the target objects in the adjacent frames of images are the same object. In this way, this helps improve object recognition accuracy.

In a possible design, before the terminal device recognizes the first target object in the first frame of image, the terminal device may further detect a user operation, in response to the user operation, open a camera application, start a camera, and display a framing interface, and display, in the framing interface, a preview image collected by the camera, where the preview image includes the first frame of image and the second frame of image.

In this embodiment, the camera application in the terminal device (for example, a mobile phone) may be used to recognize an object, and may be used to recognize whether objects in a dynamically changing preview image are a same object, to help improve object recognition accuracy.

In a possible design, a first control is displayed in the framing interface, and when the first control is triggered, the terminal device recognizes a target object in the preview image.

In this embodiment, an object recognition function of the terminal device (for example, a camera application in a mobile phone) may be enabled or disabled through a control. This is relatively flexible and an operation is convenient.

In a possible design, after the terminal device recognizes that the first target object and the second target object are the same object, the terminal device may further output prompt information, where the prompt information is used to indicate that the first target object and the second target object are the same object.

In this embodiment, when the terminal device recognizes that target objects in two frames of images are a same object, the terminal device notifies a user that the target objects are the same object, to help the user track the object, and improve accuracy of tracking the target object.

In a possible design, before the terminal device recognizes the first target object in the first frame of image, the terminal device may further display the first frame of image. After the terminal device recognizes the first target object in the first frame of image, the terminal device may display a tag of the first target object in the first frame of image, where the tag includes related information of the first target object. Before the terminal device recognizes the second target object in the second frame of image, the terminal device may further display the second frame of image. After the terminal device determines that the first target object and the second target object are the same object, the terminal device continues displaying the tag in the second frame of image.

In this embodiment, when recognizing a same target object in two frames of images, the terminal device may display a same tag, where the tag includes related information of the target object. In this way, object recognition accuracy is improved, and user experience is improved. In addition, the tag may be used to display the related information of the object, so that the user can conveniently view the related information.

In a possible design, after the terminal device determines that the first target object and the second target object are the same object, a display location of the tag is changed depending on the first target object and the second target object.

In this embodiment, when the terminal device recognizes that target objects in two frames of images are a same object, a display location of a tag of the object may be changed depending on the target objects in the images, to help the user track the object, and improve accuracy of tracking the target object.

In a possible design, before the terminal device recognizes the first target object in the first frame of image, the terminal device displays a chat interface of a communication application, where the chat interface includes a dynamic image. The terminal device detects an operation performed on the dynamic image, and displays a second control, where the second control is used to trigger the terminal device to recognize a target object in the dynamic image.

The terminal device such as a mobile phone may recognize, by using the object recognition method provided in this embodiment, an object in an image (a dynamic image or a video) sent in a WECHAT chat interface.

In a possible design, before the terminal device recognizes the first target object in the first frame of image, the terminal device is in a screen-locked state, and the terminal device collects at least two frames of face images. After the terminal determines that a face in the first frame of image and a face in the second frame of image are a same face, the terminal device is unlocked.

In this embodiment, when the terminal device collects a plurality of frames of face images, and faces in the plurality of frames of face images are a same face, the terminal device is unlocked, to improve facial recognition accuracy.

In a possible design, before the terminal device recognizes the first target object in the first frame of image, the terminal displays a payment verification interface, and the terminal device collects at least two frames of face images. After the terminal determines that a face in the first frame of image and a face in the second frame of image are a same face, the terminal performs a payment procedure.

In this embodiment, when the terminal device displays a payment interface (for example, a WECHAT payment interface or an ALIPAY payment interface), the terminal device collects a plurality of frames of face images, and faces in the plurality of frames of images are a same face, a payment procedure is completed. In this way, payment security is improved.

According to a second aspect, an embodiment provides a terminal device. The terminal device includes a processor and a memory. The memory is configured to store one or more computer programs. When the one or more computer programs stored in the memory are executed by the processor, the terminal device is enabled to implement the technical solution according to any one of the first aspect or the possible designs of the first aspect of the embodiments.

According to a third aspect, an embodiment further provides a terminal device. The terminal device includes modules/units that perform the method according to any one of the first aspect or the possible designs of the first aspect. These modules/units may be implemented by hardware, or may be implemented by hardware by executing corresponding software.

According to a fourth aspect, an embodiment provides a chip. The chip is coupled to a memory in an electronic device, to perform the technical solution according to any one of the first aspect or the possible designs. In the disclosure, “coupling” means that two components are directly or indirectly combined with each other.

According to a fifth aspect, an embodiment provides a computer storage medium. The computer readable storage medium includes a computer program, and when the computer program is run on an electronic device, the electronic device is enabled to perform the technical solution according to any one of the first aspect or the possible designs of the first aspect of the embodiments.

According to a sixth aspect, an embodiment provides a computer program product. When the computer program product runs on an electronic device, the electronic device is enabled to perform the technical solution according to any one of the first aspect or the possible designs of the first aspect of the embodiments.

### BRIEF DESCRIPTION OF DRAWINGS

FIG. 1 is a schematic diagram of a camera imaging process according to an embodiment of the present disclosure.

FIG. 2 is a schematic structural diagram of a mobile phone according to an embodiment of the present disclosure.

FIG. 3 is a schematic structural diagram of a mobile phone according to an embodiment of the present disclosure.

FIG. 4 is a schematic flowchart of an object recognition method according to an embodiment of the present disclosure.

FIG. 5 is a schematic flowchart of an object recognition method according to an embodiment of the present disclosure.

FIG. 6 is a schematic diagram of a moving speed of a pixel according to an embodiment of the present disclosure.

FIG. 7 is a schematic diagram of a display interface of a mobile phone according to an embodiment of the present disclosure.

FIG. 8(a) and FIG. 8(b) are a schematic diagram of a display interface of a mobile phone according to an embodiment of the present disclosure.

FIG. 9 is a schematic diagram of a display interface of a mobile phone according to an embodiment of the present disclosure.

FIG. 10 is a schematic diagram of a display interface of a mobile phone according to an embodiment of the present disclosure.

### DESCRIPTION OF EMBODIMENTS

The following describes the technical solutions in the embodiments of this disclosure with reference to accompanying drawings in the embodiments.

The following describes some terms in the embodiments, to facilitate understanding for a person skilled in the art.

A raw image in the embodiments of this disclosure is raw data obtained by a camera by converting a collected optical signal reflected by a target object into a digital image signal. The raw data may be data that is not processed. For example, the raw image may be data in a raw format. The data in the raw format includes information about the target object and a camera parameter. The camera parameter includes International Organization for Standardization (ISO), a shutter speed, an aperture value, white balance, or the like.

A preview image in the embodiments of this disclosure is an image obtained after a terminal device processes a raw image. For example, the terminal device converts, based on a camera parameter in the raw image, the raw image into an image, such as a red-green-blue (RGB) image or luminance-chrominance (YUV) data, that includes color information. Usually, the preview image may be presented in an interface, such as a framing interface, of a camera application.

It should be noted that because the raw image collected by the camera dynamically changes (for example, a user holds the terminal device and moves, and consequently a coverage of the camera changes, or a location or a form of a target object changes), in other words, the raw image may include a plurality of frames of images, locations or forms of target objects (for example, persons or animals) included in different frames of images are different. Therefore, the preview image also dynamically changes. In other words, the preview image may also include a plurality of frames of images.

The preview image or the raw image may be used as an input image of an object recognition algorithm provided in the embodiments of this disclosure. An example in which the preview image is used as the input image of the object recognition algorithm provided is used below.

It should be noted that an image, for example, a raw image or a preview image, in the embodiments of this disclosure may be in a form of a picture, or may be a set of data, for example, a set of some parameters (for example, a pixel and color information).

The pixel in the embodiments of this disclosure is a minimum imaging unit in a frame of image. One pixel may correspond to one coordinate point in a corresponding image. One pixel may correspond to one parameter (for example, grayscale), or may correspond to a set of a plurality of parameters (for example, grayscale, luminance, and a color).

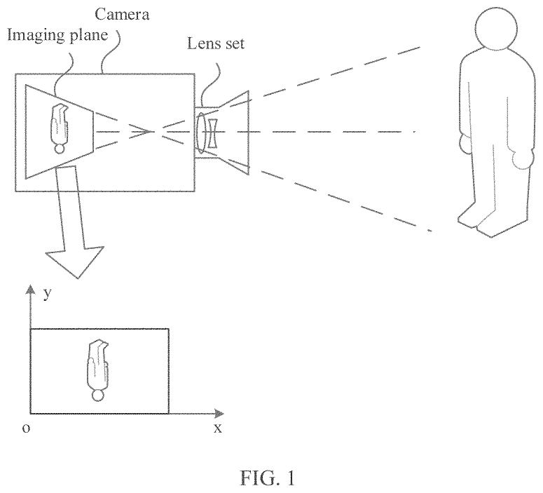

An image plane coordinate system in the embodiments of this disclosure is a coordinate system established on an imaging plane. FIG. 1 is a schematic diagram of a camera imaging process according to an embodiment of this disclosure. As shown in FIG. 1, when photographing a person, a camera collects an image of the person, and presents the collected image of the person on an imaging plane. In FIG. 1, an image plane coordinate system is represented by o-x-y, where o is an origin of the image plane coordinate system, and an x-axis and a y-axis each are a coordinate axis of the image plane coordinate system. Pixels in a raw image or a preview image may be represented in the image plane coordinate system.

“At least one” in the embodiments of this disclosure is used to indicate “one or more”. “A plurality of” means “two or more”.

It should be noted that the term “and/or” in this specification describes only an association relationship for describing associated objects and represents that three relationships may exist. For example, A and/or B may represent the following three cases only A exists, both A and B exist, and only B exists. In addition, unless otherwise stated, the character “/” in this specification usually indicates an “or” relationship between the associated objects. In the descriptions of the embodiments of the present disclosure, terms such as “first” and “second” are only used for distinction and description, but cannot be understood as indication or implication of relative importance, and cannot be understood as an indication or implication of a sequence.

The following describes a terminal device, a graphical user interface (GUI) used for the terminal device, and embodiments for using the terminal device. In some embodiments of this disclosure, the terminal device may be a portable terminal, such as a mobile phone or a tablet computer, including a component having an image collection function, such as a camera. An example embodiment of the portable terminal device includes but is not limited to a portable terminal device using iOS®, Android®, Microsoft®, or another operating system. The portable terminal device may alternatively be another portable terminal device, for example, a digital camera, provided that the portable terminal device has an image collection function. It should be further understood that in some other embodiments, the terminal device may alternatively be a desktop computer having an image collection function, but not a portable electronic device.

The terminal device usually supports a plurality of applications, for example, one or more of the following applications a camera application, an instant messaging application, or a photo management application. There may be a plurality of instant messaging applications, for example, WECHAT, TENCENT chat software (QQ), WHATSAPP Messenger, LINE, INSTAGRAM, KAKAO TALK, and DINGTALK. A user may send information such as text, voice, a picture, a video file, and another file to another contact through the instant messaging application. Alternatively, a user may implement a video call or a voice call with another contact through the instant messaging application.

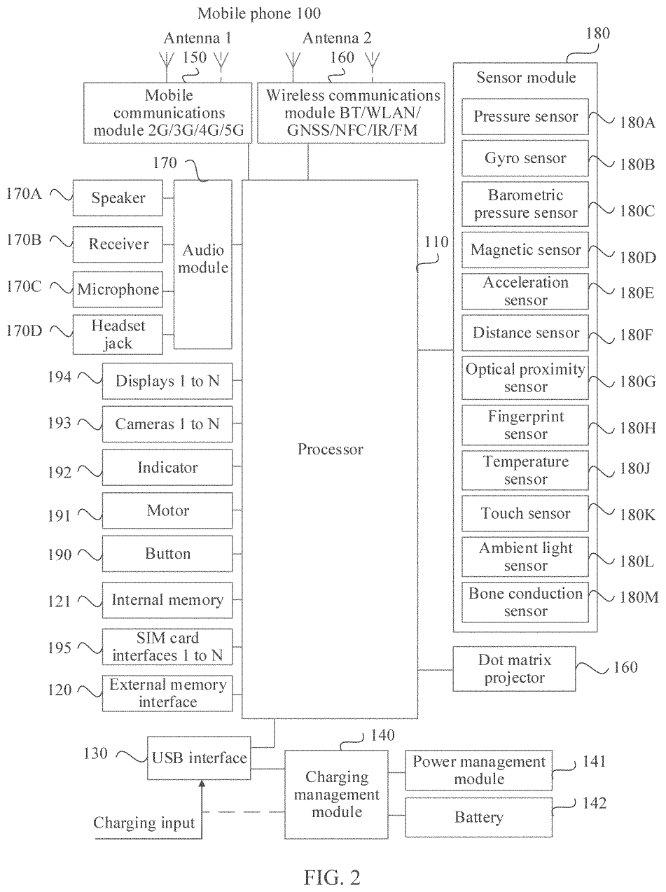

For example, the terminal device is a mobile phone. FIG. 2 is a schematic structural diagram of a mobile phone 100.

The mobile phone 100 may include a processor 110, an external memory interface 120, an internal memory 121, a Universal Serial Bus (USB) interface 130, a charging management module 140, a power management module 141, a battery 142, an antenna 1, an antenna 2, a mobile communications module 150, a wireless communications module 160, an audio module 170, a speaker 170A, a receiver 170B, a microphone 170C, a headset jack 170D, a sensor module 180, a button 190, a motor 191, an indicator 192, a camera 193, a display 194, a subscriber identification module (SIM) card interface 195, and the like. The sensor module 180 may include a pressure sensor 180A, a gyro sensor 180B, a barometric pressure sensor 180C, a magnetic sensor 180D, an acceleration sensor 180E, a distance sensor 180F, an optical proximity sensor 180G, a fingerprint sensor 180H, a temperature sensor 180J, a touch sensor 180K, an ambient light sensor 180L, a bone conduction sensor 180M, and the like.

It may be understood that a structure shown in this embodiment of the present disclosure does not constitute a specific limitation on the mobile phone 100. In some other embodiments, the mobile phone 100 may include more or fewer components than those shown in the figure, combine some components, split some components, or have different component arrangements. The components shown in the figure may be implemented by hardware, software, or a combination of software and hardware.

The processor 110 may include one or more processing units. For example, the processor 110 may include an application processor, a modem processor, a graphics processing unit (GPU), an image signal processor (ISP), a controller, a memory, a video codec, a digital signal processor (DSP), a baseband processor, and/or a neural network processing unit (NPU). Different processing units may be independent components, or may be integrated into one or more processors.

The controller may be a nerve center and a command center of the mobile phone 100. The controller may generate an operation control signal based on instruction operation code and a time sequence signal, to complete control of instruction reading and instruction execution.

The memory may be further disposed in the processor 110, and is configured to store an instruction and data. In some embodiments, the memory in the processor 110 is a cache memory. The memory may store an instruction or data just used or cyclically used by the processor 110. If the processor 110 needs to use the instruction or the data again, the processor 110 may directly invoke the instruction or the data from the memory. This avoids repeated access and reduces a waiting time of the processor 110, thereby improving system efficiency.

The mobile phone 100 implements a display function by using the GPU, the display 194, the application processor, and the like. The GPU is a microprocessor for image processing, and connects the display 194 to the application processor. The GPU is configured to perform mathematical and geometric calculation, and render an image. The processor 110 may include one or more GPUs that execute a program instruction to generate or change display information.

The display 194 is configured to display an image, a video, and the like. The display 194 includes a display panel. The display panel may be a liquid-crystal display (LCD), an organic light-emitting diode (OLED), an active-matrix OLED (AMOLED), a flexible light-emitting diode (FLED), a mini light-emitting diode (LED), a micro LED, a micro OLED, quantum dot LED (QLED), or the like. In some embodiments, the mobile phone 100 may include one or N displays 194, where N is a positive integer greater than 1.

The mobile phone 100 may implement an image photographing function by using the processor 110, the camera 193, the display 194, and the like. The camera 193 is configured to capture a static image, a dynamic image, or a video. Usually, the camera 193 may include a photosensitive element (for example, a lens set) and an image sensor. The lens set includes a plurality of lenses (convex lenses or concave lenses), and is configured to collect an optical signal reflected by a target object, and transfer the collected optical signal to the image sensor. The image sensor generates a raw image of the target object based on the optical signal. The image sensor sends the generated raw image to the processor 110. The processor 110 processes the raw image (for example, converts the raw image into an image, such as an RGB image or YUV data, that includes color information), to obtain a preview image. The display 194 displays the preview image.

After the processor 110 runs the object recognition algorithm provided in the embodiments of this disclosure to recognize an object in the preview image (for example, the user actively triggers the processor 110 to run the object recognition algorithm provided in this embodiment to recognize the target object in the preview image), the display 194 displays the preview image and related information of the target object recognized from the preview image.

The internal memory 121 may be configured to store computer executable program code. The executable program code includes an instruction. The processor 110 runs the instruction stored in the internal memory 121, to implement various function applications of the mobile phone 100 and data processing. The internal memory 121 may include a program storage area and a data storage area. The program storage area may store an operating system, an application required by at least one function (for example, a sound playing function or an image playing function), and the like. The data storage area may store data (for example, audio data or an address book) created during use of the mobile phone 100, and the like. In addition, the internal memory 121 may include a high-speed random access memory, and may further include a nonvolatile memory, for example, at least one magnetic disk storage device, a flash memory device, or a universal flash storage (UFS).

The distance sensor 180F is configured to measure a distance. The mobile phone 100 may measure a distance through infrared light or a laser. In some embodiments, in a photographing scenario, the mobile phone 100 may measure a distance by using the distance sensor 180F, to implement fast focusing. In some other embodiments, the mobile phone 100 may further detect, by using the distance sensor 180F, whether a person or an object approaches.

For example, the optical proximity sensor 180G may include a LED and an optical detector, for example, a photodiode. The light-emitting diode may be an infrared light-emitting diode. The mobile phone 100 emits infrared light by using the light-emitting diode. The mobile phone 100 detects infrared reflected light from a nearby object by using the photodiode. When sufficient reflected light is detected, the mobile phone 100 may determine that there is an object near the mobile phone 100. When insufficient reflected light is detected, the mobile phone 100 may determine that there is no object near the mobile phone 100. The mobile phone 100 may detect, by using the optical proximity sensor 180G, that the user holds the mobile phone 100 close to an ear to make a call, so as to automatically turn off a screen for power saving. The optical proximity sensor 180G may also be used in a leather case mode or a pocket mode to automatically unlock or lock the screen.

The ambient light sensor 180L is configured to sense luminance of ambient light. The mobile phone 100 may adaptively adjust luminance of the display 194 based on the sensed luminance of the ambient light. The ambient light sensor 180L may also be configured to automatically adjust white balance during photographing. The ambient light sensor 180L may also cooperate with the optical proximity sensor 180G to detect whether the mobile phone 100 is in a pocket to prevent an accidental touch.

The fingerprint sensor 180H is configured to collect a fingerprint. The mobile phone 100 may use a feature of the collected fingerprint to implement fingerprint unlocking, application access locking, fingerprint photographing, fingerprint call answering, and the like.

The temperature sensor 180J is configured to detect a temperature. In some embodiments, the mobile phone 100 executes a temperature processing policy based on the temperature detected by the temperature sensor 180J. For example, when the temperature reported by the temperature sensor 180J exceeds a threshold, the mobile phone 100 lowers performance of a processor near the temperature sensor 180J, to reduce power consumption for thermal protection. In some other embodiments, when the temperature is less than another threshold, the mobile phone 100 heats the battery 142 to prevent the mobile phone 100 from being shut down abnormally because of a low temperature. In some other embodiments, when the temperature is less than still another threshold, the mobile phone 100 boosts an output voltage of the battery 142 to avoid abnormal shutdown caused by a low temperature.

The touch sensor 180K is also referred to as a “touch panel”. The touch sensor 180K may be disposed on the display 194, and the touch sensor 180K and the display 194 form a touchscreen, which is also referred to as a “touchscreen”. The touch sensor 180K is configured to detect a touch operation performed on or near the touch sensor 180K. The touch sensor may transfer the detected touch operation to the application processor, to determine a type of a touch event. Visual output related to the touch operation may be provided by using the display 194. In some other embodiments, the touch sensor 180K may alternatively be disposed on a surface of the mobile phone 100 and is at a location different from that of the display 194.

In addition, the mobile phone 100 may implement an audio function such as music playing or recording by using the audio module 170, the speaker 170A, the receiver 170B, the microphone 170C, the headset jack 170D, the application processor, and the like. The mobile phone 100 may receive input of the button 190, and generate button signal input related to a user setting and function control of the mobile phone 100. The mobile phone 100 may generate a vibration prompt (for example, an incoming call vibration prompt) by using the motor 191. The indicator 192 of the mobile phone 100 may be an indicator light, and may be configured to indicate a charging status and a battery level change, or may be configured to indicate a message, a missed call, a notification, and the like. The SIM card interface 195 of the mobile phone 100 is configured to connect to a SIM card. The SIM card may be inserted into the SIM card interface 195 or plugged from the SIM card interface 195, to implement contact with or separation from the mobile phone 100.

A wireless communication function of the mobile phone 100 may be implemented by using the antenna 1, the antenna 2, the mobile communications module 150, the wireless communications module 160, the modem processor, the baseband processor, and the like.

The antenna 1 and the antenna 2 are configured to transmit and receive electromagnetic wave signals. Each antenna in the electronic device 100 may be configured to cover one or more communication frequency bands. Different antennas may be further multiplexed to improve antenna utilization. For example, the antenna 1 may be multiplexed as a diversity antenna in a wireless local area network (WLAN). In some other embodiments, an antenna may be used in combination with a tuning switch.

The mobile communications module 150 may provide a wireless communication solution that includes 2nd generation (2G)/3rd generation (3G)/4th generation (4G)/5th generation (5G) or the like and that is applied to the electronic device 100. The mobile communications module 150 may include at least one filter, a switch, a power amplifier, a low noise amplifier (LNA), and the like. The mobile communications module 150 may receive an electromagnetic wave through the antenna 1, perform processing such as filtering or amplification on the received electromagnetic wave, and transmit a processed electromagnetic wave to the modem processor for demodulation. The mobile communications module 150 may further amplify a signal modulated by the modem processor, and convert the signal into an electromagnetic wave for radiation through the antenna 1. In some embodiments, at least some function modules of the mobile communications module 150 may be disposed in the processor 110. In some embodiments, at least some function modules of the mobile communications module 150 and at least some modules of the processor 110 may be disposed in a same device.

The modem processor may include a modulator and a demodulator. The modulator is configured to modulate a to-be-sent low-frequency baseband signal into a medium or high-frequency signal. The demodulator is configured to demodulate a received electromagnetic wave signal into a low-frequency baseband signal. Then, the demodulator transmits the low-frequency baseband signal obtained through demodulation to the baseband processor for processing. The low-frequency baseband signal is processed by the baseband processor, and then transmitted to the application processor. The application processor outputs a sound signal by using an audio device (which is not limited to the speaker 170A, the receiver 170B, or the like), or displays an image or a video through the display 194. In some embodiments, the modem processor may be an independent component. In some other embodiments, the modem processor may be independent of the processor 110, and is disposed in a same device as the mobile communications module 150 or another function module.

The wireless communications module 160 may provide a wireless communication solution that includes a WLAN (for example, a WI-FI network), BLUETOOTH (BT), a global navigation satellite system (GNSS), frequency modulation, a near field communication (NFC) technology, an infrared technology, or the like and that is applied to the electronic device 100. The wireless communications module 160 may be one or more devices that integrate at least one communications processing module. The wireless communications module 160 receives an electromagnetic wave through the antenna 2, performs frequency modulation and filtering processing on an electromagnetic wave signal, and sends a processed signal to the processor 110. The wireless communications module 160 may further receive a to-be-sent signal from the processor 110, perform frequency modulation and amplification on the signal, and convert the signal into an electromagnetic wave for radiation through the antenna 2.

All the following embodiments may be implemented in a terminal device (for example, the mobile phone 100 or a tablet computer) having the foregoing hardware structure.

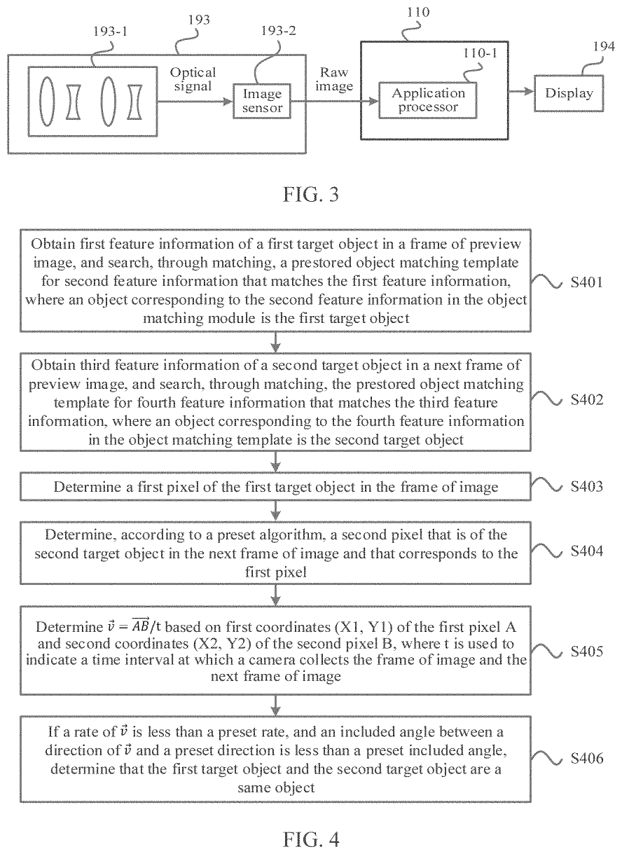

To facilitate description of the object recognition algorithm provided in the embodiments of this disclosure, the following describes the object recognition algorithm using components related to the object recognition algorithm provided in the embodiments of this disclosure. For details, refer to FIG. 3. For components in FIG. 3, refer to the related descriptions in FIG. 1. It should be noted that an example in which an application processor 110-1 is integrated into the processor 110 is used in FIG. 3.

In some embodiments, the mobile phone 100 shown in FIG. 3 may recognize an object in the following process.

The display 194 of the mobile phone 100 displays a home screen, and the home screen includes various application icons (for example, a phone application icon, a video player icon, a music player icon, a camera application icon, and a browser application icon). The user taps an icon of a camera application on the home screen by using the touch sensor 180K (not shown in FIG. 2, and reference may be made to FIG. 1) disposed on the display 194, to open the camera application and start the camera 193. The display 194 displays an interface of the camera application, for example, a framing interface.

A lens set 193-1-1 in the camera 193 collects an optical signal reflected by a target object, and transfers the collected optical signal to an image sensor 193-2. The image sensor 193-2 generates a raw image of the target object based on the optical signal. The image sensor 315-2 sends the raw image to the application processor 110-1. The application processor 110-1 processes the raw image (for example, converts the raw image into an RGB image) to obtain a preview image. Alternatively, the image sensor 315-2 may send the raw image to another processor (for example, an ISP, which is not shown in FIG. 3), and the ISP processes the raw image to obtain a preview image. The ISP sends the preview image to the application processor 110-1.

In some embodiments, a specific control may be displayed in the interface of the camera application. When the control is triggered, the mobile phone 100 enables a function of recognizing an object in the preview image. Specifically, the touch sensor 180K in the mobile phone 100 detects that the user taps the specific control in the interface (for example, the framing interface) of the camera application, and triggers the application processor 301-1 to run code of the object recognition algorithm provided in this embodiment, to recognize the target object in the preview image.

In some other embodiments, after obtaining the preview image (for example, the application processor converts the raw image into an RGB image), the application processor 110-1 may alternatively automatically run code of the object recognition algorithm provided in this embodiment, to recognize an object in the preview image, and the user does not need to actively trigger object recognition.

In either manner, when the application processor 110-1 recognizes the target object in the preview image, the display 194 displays related information (for example, a name and a type of the target object, which are described below) of the target object.

It should be noted that an example in which the application processor 110-1 is integrated into the processor 110 is used in the foregoing content. Actually, only a GPU may be integrated into the processor 110, and the GPU is configured to perform a function of the application processor 110-1 in the foregoing content. Alternatively, only a central processing unit (CPU) may be integrated into the processor 110, and the CPU is configured to perform a function of the application processor 110-1 in the foregoing content. In conclusion, a subject that runs the code of the object recognition algorithm provided in this disclosure is not limited in this embodiment.

In this embodiment, the camera 193 may continuously collect images at a specific time interval, that is, collect a plurality of frames of images. Therefore, if each of the plurality of frames of images includes a different target object (at a different location, in a different form, and the like), when the plurality of frames of images are displayed in the interface (for example, the framing interface) for the camera application, an effect of a dynamic picture change is presented. For example, a location of the target object changes (for example, the target object is displaced, and moves from a first location to a second location) or a form of the target object changes (for example, the target object changes from a first form to a second form). Consequently, a display location and a form of the target object in each of the plurality of frames of raw images collected by the camera 193 change. The raw image dynamically changes. In other words, the preview image also dynamically changes.

To accurately recognize the target object in the preview image, in this embodiment, there may be two processes in which the application processor 301-1 runs the code of the object recognition algorithm provided in this embodiment to recognize the target object in the preview image. In a first process, the application processor 110-1 may recognize a target object in each frame of preview image. In a second process, when a similarity between two target objects in adjacent frames of images is greater than a preset similarity (for example, the two target objects belong to a same object type), the application processor 110-1 determines whether the two target objects are a same object. To be specific, when the similarity between the two target objects in the adjacent frames of images is higher, it indicates that there is a higher probability that the two target objects are the same object, and the application processor 110-1 may further determine whether the two target objects are the same object. For example, the application processor 110-1 may determine a correlation between the target objects in the adjacent frames of images. If the correlation exists (for example, a speed of moving between pixels of the target objects in the adjacent frames of images is less than or equal to a preset speed), the target objects in the adjacent frames of images are the same object (a specific process is described below). If the correlation does not exist (for example, a speed of moving between pixels of the target objects in the adjacent frames of images is greater than a preset speed), the target objects in the adjacent frames of images are different objects.

For example, the user opens a camera application in the mobile phone 100 to photograph a cat. A form of the cat is changing (such as lying or standing). Therefore, a preview image in a framing interface of the camera application dynamically changes. The mobile phone 100 may recognize that each frame of image includes a cat. However, in different frames of images, a form of the cat changes. Therefore, the mobile phone 100 may further determine whether cats included in adjacent frames of images are the same cat.

It should be noted that in the conventional technology, when recognizing objects in a plurality of frames of images (for example, a video or a dynamic image), the terminal device recognizes an object in each frame of image. It is assumed that after the terminal device recognizes an object in a first frame of image, a form of the object in a next frame of image changes, and therefore the terminal device re-recognizes the object in the next frame of image. Because the form changes, the terminal device may fail to recognize the object. Alternatively, because the form of the object changes, the terminal device recognizes the object as another object, in other words, recognizes the object incorrectly. However, actually, the object in the next frame of image and the object in the first frame of image are the same object.

According to the object recognition method provided in this embodiment, when recognizing target objects in a plurality of frames of images (for example, a video or a dynamic image), the terminal device may consider a correlation (for example, a speed of moving between pixels of target objects in adjacent frames of images) between the adjacent frames of images to determine whether the target objects in the adjacent frames of images are the same object. Therefore, in this embodiment, the terminal device can not only recognize the target object in each of the plurality of frames of images (for example, the video or the dynamic image), but also recognize whether the target objects in the plurality of frames of images are the same object, to improve object recognition accuracy.

The following describes a process in which the application processor 110-1 runs code of the object recognition algorithm provided in this embodiment to recognize the target object in the preview image (a plurality of frames of preview images).

FIG. 4 is a schematic flowchart of an object recognition method according to an embodiment of this disclosure. As shown in FIG. 4, an application processor 110-1 runs code of an object recognition algorithm to perform the following process.

S401. Obtain first feature information of a first target object in a frame of preview image, and search, through matching, a prestored object matching template for second feature information that matches the first feature information, where an object corresponding to the second feature information in the object matching module is the first target object.

A mobile phone 100 may obtain the first feature information of the first target object in the frame of preview image in a plurality of implementations, for example, foreground/background separation and an edge detection algorithm. This is not limited in this embodiment.

In this embodiment, the mobile phone 100 may store the object matching template, and the object matching template includes feature information of different types of objects. Feature information of an object includes an edge contour, color information and texture information of a feature point (such as an eye, a mouth, or a tail), and the like of the object. The object matching template may be set before delivery of the mobile phone 100, or may be customized by a user in a process of using the mobile phone 100.

It is assumed that the object matching template is set before delivery of the mobile phone 100. The following describes a process of obtaining the object matching template before delivery of the mobile phone 100.

A designer may use a plurality of images of a same target object as input images of the mobile phone 100, to recognize the plurality of images. The target object in each image has a different form. Therefore, the mobile phone 100 obtains feature information of the target object in each image.

For example, the target object is a cat. The designer may obtain 100 images (for example, photographed by the designer or obtained from a network side) of the cat in different forms. The cat in each of the 100 images has a different form. The mobile phone 100 recognizes the target object (for example, the cat) in each image, and stores feature information of the target object (for example, the cat), to obtain feature information of the target object in 100 forms. The feature information may include an edge contour, color information and texture information of a feature point (such as an eye, a mouth, or a tail), and the like of the target object in each form.

For example, the mobile phone 100 may store the feature information of the object in a table (for example, Table 1), namely, the object matching template.

TABLE 1

| | Object | | |
|---|---|---|---|
| Object | type | Form | Feature information |
| Animal | Cat | Lying | Edge contour 1, and color information and |
| template | | | texture information of a feature point 1 |
| | | Standing | Edge contour 2, and color information and |
| | | | texture information of a feature point 2 |
| | Dog | Standing | Edge contour 3, and color information and |
| | | | texture information of a feature point 3 |

Table 1 shows only two form templates (for example, lying or standing) of an object type such as a cat. In actual application, another form may also be included. In other words, Table 1 shows only an example of an object matching template, and a person skilled in the art may detail Table 1. Still using the foregoing example, the designer obtains the 100 images of the cat in different forms for recognition, and obtains feature information of the cat in 100 forms. In other words, there are 100 forms corresponding to the cat in Table 1. Certainly, there are a plurality of types of cats, and feature information of different types of cats (that is, there are a plurality of object types of the cats) in various forms may be obtained in a similar manner. This is not limited in this embodiment.

Therefore, in this embodiment, when recognizing a target object in a frame of preview image, the application processor 110-1 may first obtain feature information (an edge contour, color information and texture information of a feature point, and the like) of the target object in the frame of preview image. If the obtained feature information matches a piece of feature information in the object matching template (for example, Table 1), the application processor 110-1 determines that an object corresponding to the feature information obtained through matching is the target object. Therefore, the object matching template may include as many objects as possible (for example, objects whose forms may change, such as an animal and a person), and feature information of each object in different forms to recognize different objects in all frames of images. In this way, the mobile phone 100 stores feature information of various objects in different forms. Therefore, the application processor 110-1 can recognize a target object in different forms in each frame of image. Certainly, the object matching template may alternatively be updated, for example, manually updated by the user or automatically updated by the mobile phone 100.

S402. Obtain third feature information of a second target object in a next frame of preview image, and search, through matching, the prestored object matching template for fourth feature information that matches the third feature information, where an object corresponding to the fourth feature information in the object matching template is the second target object.

It can be learned from the foregoing content that the preview image dynamically changes. Therefore, in this embodiment, the application processor 110-1 may perform S401 on each frame of preview image. After determining the first target object in the frame of image, the application processor 110-1 may recognize the second target object in the next frame of preview image in a same manner. Because the application processor 110-1 recognizes the first target object and the second target object in the same manner (through the object matching template), the recognized first target object and the recognized second target object may be of a same object type (for example, both are cats), or may be of different object types (for example, the first target object is a cat, and the second target object is a dog).

In an example, when the recognized first target object and the recognized second target object are of a same object type (for example, both are cats), the application processor 110-1 may determine that the two target objects are the same object. In another example, to improve object recognition accuracy, when the recognized first target object and the recognized second target object are of a same object type, the application processor 110-1 may further continue to determine whether the first target object and the second target object are the same object, that is, continue to perform a subsequent step. When the recognized first target object and the recognized second target object are of different object types, the application processor 110-1 may not perform the subsequent step.

S403. Determine a first pixel of the first target object in the frame of image.

It should be noted that each frame of image is presented on an imaging plane. Therefore, after recognizing the first target object, the application processor 110-1 may determine the first pixel of the first target object in an image plane coordinate system. The first pixel may be a coordinate point at a central location of the first target object, or a coordinate point at a location of a feature point (for example, an eye) of the first target object.

S404. Determine, according to a preset algorithm, a second pixel that is of the second target object in the next frame of image and that corresponds to the first pixel.

The application processor 110-1 selects the first pixel in a plurality of possible cases. For example, the first pixel is the central location coordinates of the first target object or a coordinate point at a location of a feature point of the first target object. Assuming that the first pixel is the coordinate point at the central location of the first target object, the second pixel is a coordinate point at a central location of the second target object. Specifically, the application processor 110-1 may determine a central location of the target object according to a filtering algorithm (for example, a Kalman filtering algorithm). Details are not described in this embodiment. Assuming that the first pixel is a feature point (for example, an eye) of the first target object, the second pixel is a feature point (for example, an eye) of the second target object. Specifically, the application processor 110-1 may search, according to a matching algorithm (for example, a similarity matching algorithm), the second target object for a feature point that matches the feature point of the first target object.

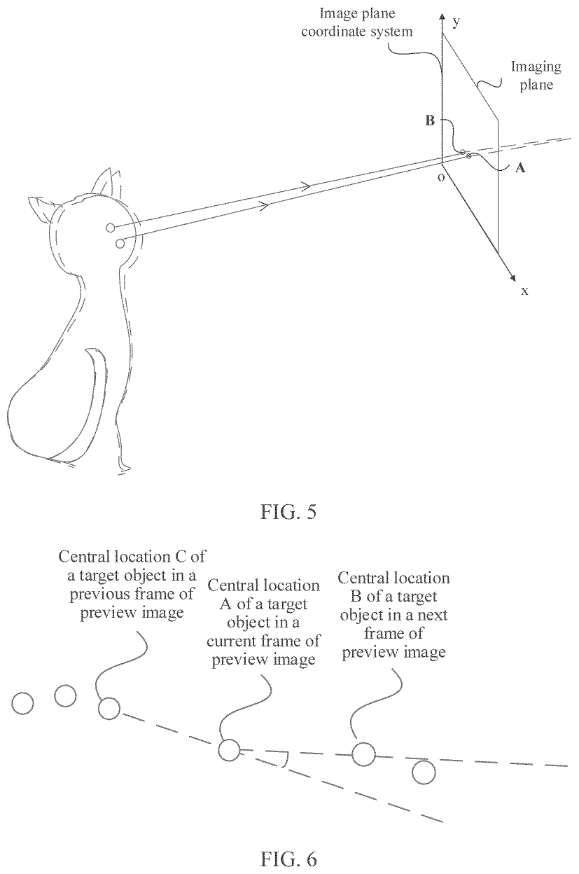

Referring to FIG. 5, for example, the target object is a cat. A form of the cat changes. A camera collects a plurality of frames of preview images. A frame of preview image is photographed for a cat in a solid line state, and a next frame of preview image is photographed for a cat in a dashed line state. The application processor 110-1 recognizes that the two target objects in the two frames of preview images are both cats. The application processor 110-1 determines that the first pixel of the first target object (the cat in the solid line state) in the frame of preview image is a point A on the imaging plane. The application processor 110-1 determines that the second pixel of the second target object (the cat in the dashed line state) in the next frame of preview image is a point B on the imaging plane. It should be noted that a pixel in the frame of image and a pixel in the next frame of image are both presented on the imaging plane. Therefore, in FIG. 5, the first pixel in the frame of image and the second pixel in the next frame of image are both marked on the imaging plane. However, actually, the first pixel and the second pixel are pixels in two different images.

S405. Determine \vec{v}=\vec{AB}/t based on first coordinates (x1, y1) of the first pixel A and second coordinates (x2, y2) of the second pixel B, where t is used to indicate a time interval at which the camera collects the frame of image and the next frame of image.

It should be noted that when a location or a form of the target object changes, that is, when an object point on the target object changes, an image point (a pixel in the image plane coordinate system) corresponding to the object point also changes, and correspondingly, a display location of the target object in the preview image changes. Therefore, a change status of the location or the form of the object in the preview image may reflect a change status of a location or a form of an object in a real environment.

Usually, a time interval (for example, 30 milliseconds (ms)) at which a camera 193 collects two frames of images is relatively short. The time interval may be set before delivery of the mobile phone 100, or may be customized by the user in a process of using the mobile phone 100. However, at the time interval, the location or the form of the target object in the real environment slightly changes. To be specific, although the location or the form of the target object in the real environment keeps changing, the camera 193 may continuously collect images of target objects at a relatively short time interval. Therefore, locations or forms of target objects in adjacent frames of images slightly change. In this case, the application processor 110-1 may determine whether a speed of moving between two pixels of two target objects in the adjacent frames of images is less than a preset speed. If the moving speed is less than the preset speed, the two target objects are the same object. If the moving speed is greater than the preset speed, the two target objects are different objects.

Therefore, the application processor 110-1 may determine \vec{v}=\vec{AB}/t, namely, a speed at which the first pixel A moves to the second pixel B, based on the first coordinates (x1, y1) of the first pixel A and the second coordinates (x2, y2) of the second pixel B.

S406. If a rate of \vec{v} is less than a preset rate v₀, and an included angle between a direction of \vec{v} and a preset direction is less than a preset included angle, determine that the first target object and the second target object are the same object.

The speed \vec{v} at which the first pixel A moves to the second pixel B includes the rate and the direction. Specifically, when the rate is less than the preset rate, and the included angle between the direction of \vec{v} and the preset direction is less than the preset angle, the first target object and the second target object are the same object. The preset rate may be set before delivery, for example, determined by the designer based on experience or an experiment.

The preset direction may be a direction determined based on an image before the frame of image. The following describes a process in which the application processor 110-1 determines the preset direction.

In an example, there are a plurality of frames of preview images. FIG. 6 shows coordinates of a central location of a target object in each frame of preview image on an imaging plane (a black dot in the figure represents a central location of a target object in a frame of preview image). Because a location or a form of the target object changes, a central location of the target object on the imaging plane also changes. The application processor 110-1 determines, based on the frame of image and a previous frame of image (an adjacent frame of image) of the frame of image, that a direction of a speed of moving between two pixels (central locations of two target objects) of the two target objects is \vec{CA}, where the direction of \vec{CA} is the preset direction.

The application processor 110-1 determines, based on the frame of image and a next frame of image (an adjacent frame of image) of the frame of image, that a direction of a speed of moving between two pixels (central locations of two target objects) of the two target objects is \vec{AB}. In this case, when an included angle between \vec{CA} and \vec{AB} is less than a preset angle (for example, 10 degrees), the application processor 110-1 determines, based on the next frame of image (the adjacent frame of image) of the frame of image, that the two target objects are the same object.

In addition, the preset direction may alternatively be a direction customized by the user, a direction that is set before delivery of the mobile phone 100, or a direction determined in another manner. This is not limited in this embodiment.

It should be noted that when determining whether the two target objects in the adjacent frames of images are the same object, the mobile phone 100 may consider both the direction and the rate that are of the speed, or may consider only the rate, but not the direction of the speed. To be specific, when the rate is greater than the preset rate, the mobile phone 100 determines that the two target objects are the same object. Alternatively, the mobile phone 100 may consider only the direction of the speed, but not the rate. To be specific, when the included angle between the direction of the speed and the preset direction is less than the preset angle, the mobile phone 100 determines that the two target objects are the same object.

It should be noted that in the foregoing embodiment, the mobile phone 100 first determines whether the first target object and the second target object are of a same object type, and then determines whether a speed of moving between the first target object and the second target object is less than the preset speed. In actual application, a sequence of the two processes is not limited. For example, the mobile phone 100 may first determine whether the speed of moving between the first target object and the second target object is less than the preset speed, and then determine whether the first target object and the second target object belong to a same object type. Alternatively, when determining that the first target object and the second target object are of a same object type, the mobile phone 100 determines that the first target object and the second target object are the same object (in this case, the mobile phone 100 does not need to determine whether the speed of moving between the first target object and the second target object is less than the preset speed). Alternatively, when determining that the speed of moving between the first target object and the second target object is less than the preset speed, the mobile phone 100 determines that the first target object and the second target object are the same object (in this case, the mobile phone 100 does not need to determine whether the first target object and the second target object are of a same object type).

It should be noted that in the embodiment shown in FIG. 4, the frame of image and the next frame of image are used as an example for description. In actual application, the application processor 110-1 may process every two adjacent frames of images in a video or a dynamic image in the procedure of the method shown in FIG. 4.

The foregoing content is described by using a camera application (a camera application built in the mobile phone 100, or another camera application, for example, BEAUTYCAM, downloaded to the mobile phone 100 from a network side) in the mobile phone 100 as an example. Actually, the object recognition algorithm provided in the embodiments of this disclosure may alternatively be applied to another scenario, for example, a scenario in which an image needs to be collected by a camera, such as a QQ video or a WECHAT video. For another example, the object recognition algorithm provided in the embodiments of this disclosure can not only be used to recognize a target object in an image collected by a camera, but also be used to recognize a target object in a dynamic image or a video sent by another device (for example, the mobile communications module 150 or the wireless communications module 160 receives the dynamic image or the video sent by the another device), or a target object in a dynamic image or a video downloaded from the network side. This is not limited in this embodiment.

In this embodiment, after recognizing the target object in the preview image, the mobile phone 100 may display related information of the target object. For example, the related information includes a name, a type, or a web page link (for example, a purchase link to purchase information of the target object) of the target object. This is not limited in this embodiment. In addition, the mobile phone 100 may display the related information of the target object in a plurality of manners. The related information of the target object may be displayed in a form of text information, or may be displayed in a form of an icon. The icon is used as an example. When detecting that the user triggers the icon, the mobile phone displays the related information of the target object.

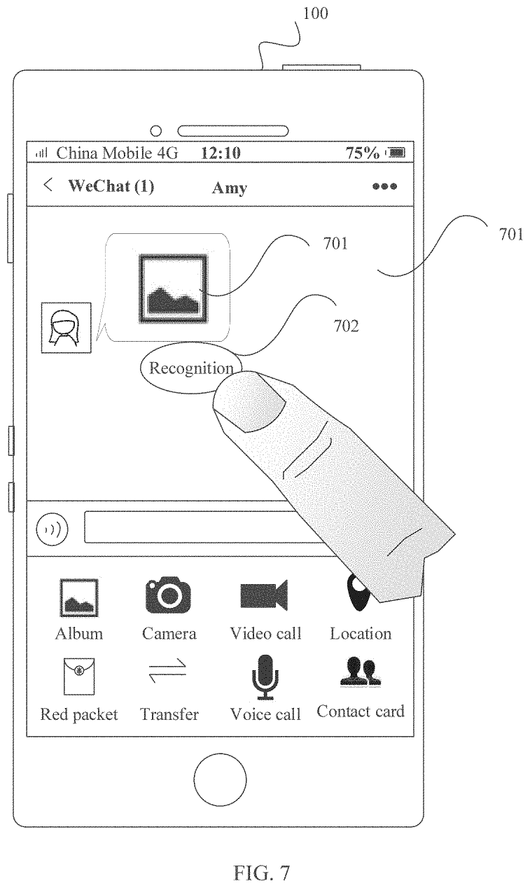

In an example, FIG. 7 to FIG. 9 show examples of several application scenarios in which the mobile phone 100 recognizes an object according to an embodiment of this disclosure.

As shown in FIG. 7, a display interface of the mobile phone 100 displays a WECHAT chat interface 701, and the chat interface 701 displays a dynamic image 702 sent by Amy. When the mobile phone 100 detects that a user triggers the dynamic image 702 (for example, touches and holds the dynamic image 702), the mobile phone 100 displays a recognition control 703. Alternatively, after detecting that the user triggers the dynamic image 702, the mobile phone 100 zooms in on the dynamic image, and when detecting that the user touches and holds the zoomed-in dynamic image, the mobile phone 100 displays the recognition control 703. When detecting that the user triggers the recognition control 703, the mobile phone 100 recognizes an object in the dynamic image 703 according to the object recognition method provided in this embodiment.

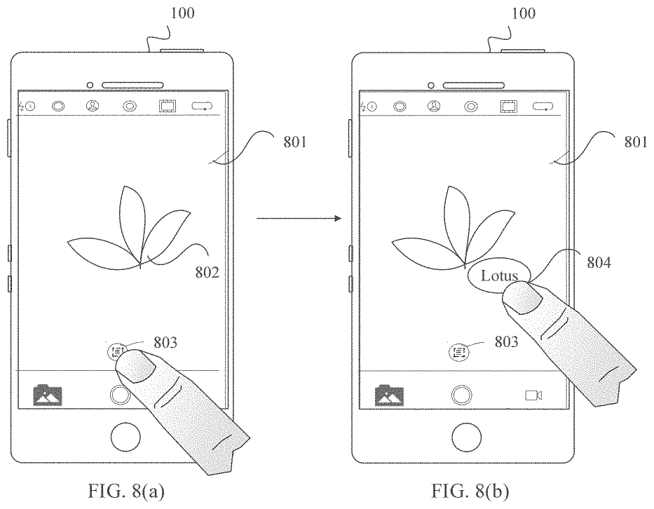

As shown in FIG. 8(a), a display interface of the mobile phone 100 displays a framing interface 801 of a camera application, and the framing interface 801 displays a preview image 802 (dynamically changing). The framing interface 801 includes a control 803. When the user triggers the control 803, an object in the preview image 802 is recognized according to the object recognition algorithm provided in this embodiment. It should be noted that the control 803 in FIG. 8(a) and FIG. 8(b) is merely used as an example. In actual application, the control 803 may alternatively be displayed in another form or at another location. This is not limited in this embodiment.

When recognizing the object in the preview image, the mobile phone 100 may display related information of the image. For example, referring to FIG. 8(b), the mobile phone 100 displays a tag 804 of the object (for example, a flower), and the tag 804 displays a name of the recognized flower. When detecting that the tag 804 is triggered, the mobile phone 100 displays more detailed information about the object (namely, the flower) (for example, displays an origin, an alias, and a planting manner that are of the flower). Alternatively, when detecting that the tag 804 is triggered, the mobile phone 100 displays another application (for example, BAIDU BAIKE), and displays more detailed information about the object in an interface of the another application. This is not limited in this embodiment. It should be noted that when a location of the object in the preview image changes, a display location of the tag 804 in the preview image may also change with the location of the object.

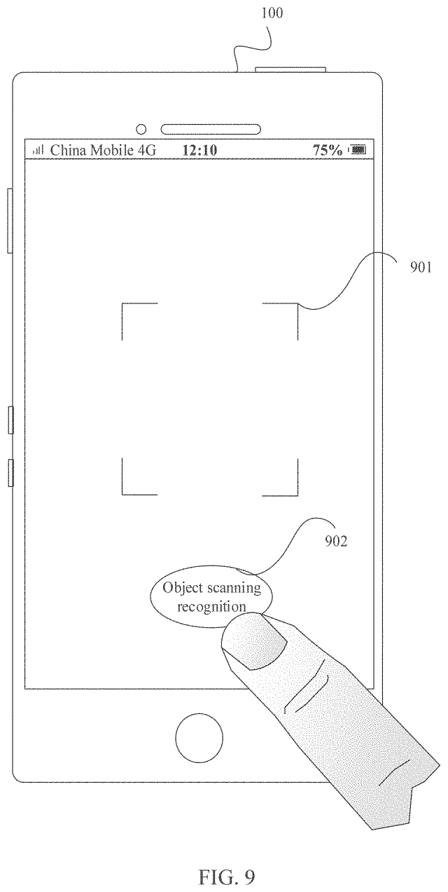

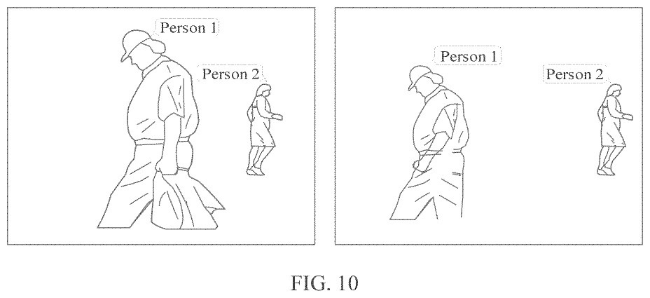

As shown in FIG. 9, the mobile phone 100 displays a scanning box 901, and when an image of an object is displayed in the scanning box 901, a scanning control 902 is displayed. When detecting that the user triggers the object scanning recognition control 902, the mobile phone 100 recognizes the image in the scanning box 901 according to the object recognition method provided in this embodiment. The embodiment shown in FIG. 9 may be applied to a scenario with a scanning function, such as TAOBAO or ALIPAY. TAOBAO is used as an example. When recognizing an object in the scanning box 901, the mobile phone 100 may display a purchase link of the object.

It should be noted that FIG. 7 to FIG. 9 show only the examples of the several application scenarios, and the object recognition algorithm provided in this embodiment may be further applied to another scenario. For example, in the video surveillance field, referring to FIG. 10, a location and a form that are of a person on a display are changing. The object recognition algorithm provided in this embodiment can be used to more accurately track a same person in a surveillance video. When a person in the video moves, a display location of a tag (a mark, such as a specific symbol or a color, used to identify a person) of the person may also move, to improve object tracking accuracy.

For another example, the object recognition algorithm provided in this embodiment of this disclosure may be applied to a scenario in which the terminal device is unlocked through facial recognition. When the mobile phone 100 collects a plurality of frames of face images, and faces in the plurality of frames of face images are a same face, the terminal device is unlocked. For another example, the object recognition algorithm provided in this embodiment may be further applied to a face payment scenario. When the mobile phone 100 displays a payment interface (for example, a WECHAT payment interface or an ALIPAY payment interface), the mobile phone 100 collects a plurality of frames of face images, and faces in the plurality of frames of images are a same face, a payment procedure is completed. Similarly, the object recognition algorithm provided in this embodiment may be further applied to a facial recognition-based punch in-out scenario. Details are not described.

For another example, a separate application may be set in the mobile phone 100. The application is used to photograph an object to recognize the object, so that the user can conveniently recognize the object.

Certainly, the object recognition method provided in this embodiment of this disclosure may be further applied to a game application, for example, an augmented reality (AR) application or a virtual reality (VR) application. VR is used as an example. A VR device (for example, a mobile phone or a computer) may recognize a same object in different images, display a tag of the object, and present the object and the tag to the user through a VR display (AR glasses).

In the foregoing embodiments, the mobile phone 100 is used as an example. A display of the mobile phone 100 displays the recognized object and the related information of the object. When the object recognition method provided in this embodiment is applicable to another scenario, the object recognized by the mobile phone 100 and the related information of the object may alternatively be displayed through another display (for example, an external display). This is not limited in this embodiment.

The implementations of this disclosure may be randomly combined to achieve different technical effects.

In the foregoing embodiments provided in this disclosure, the method provided in the embodiments is described from a perspective in which the terminal device (the mobile phone 100) is used as an execution body. To implement functions in the method provided in the embodiments of this disclosure, the terminal may include a hardware structure and/or a software module, and implement the foregoing functions in a form of the hardware structure, the software module, or a combination of the hardware structure and the software module. Whether a function in the foregoing functions is performed by the hardware structure, the software module, or the combination of the hardware structure and the software module depends on particular applications and design constraints of the technical solutions.

Based on a same concept, an embodiment provides a terminal device. The terminal device may perform the methods in the embodiments shown in FIG. 2 to FIG. 9. The terminal device includes a processing unit and a display unit.

The processing unit is configured to recognize a first target object in a first frame of image, and recognize a second target object in a second frame of image adjacent to the first frame of image, and if a similarity between the first target object and the second target object is greater than a preset similarity, and a moving speed is less than a preset speed, determine that the first target object and the second target object are a same object.

The display unit is configured to display the first frame of image or the second frame of image.

These modules/units may be implemented by hardware, or may be implemented by hardware by executing corresponding software.

When the terminal device is the mobile phone 100 shown in FIG. 2, the processing unit may be the processor 110 shown in FIG. 2, or the application processor 110-1 shown in FIG. 3, or another processor. The display may be the display 194 shown in FIG. 2, or may be another display (for example, an external display) connected to the terminal device.

An embodiment further provides a computer storage medium. The storage medium may include a memory. The memory may store a program. When the program is executed, an electronic device is enabled to perform all the steps recorded in the method embodiment shown in FIG. 4.

An embodiment further provides a computer program product. When the computer program product runs on an electronic device, the electronic device is enabled to perform all the steps recorded in the method embodiment shown in FIG. 4.

It should be noted that in the embodiments of this disclosure, division into the units is an example and is merely logical function division, and may be other division in an actual implementation. Function units in the embodiments of the present disclosure may be integrated into one processing unit, or each of the units may exist alone physically, or two or more units may be integrated into one unit. For example, in the foregoing embodiments, the first obtaining unit and the second obtaining unit may be the same or different. The integrated unit may be implemented in a form of hardware, or may be implemented in a form of a software function unit.

According to the context, the term “when” used in the foregoing embodiments may be interpreted as a meaning of “if”, “after”, “in response to determining”, or “in response to detecting”. Similarly, according to the context, the phrase “when it is determined that” or “if (a stated condition or event) is detected” may be interpreted as a meaning of “when it is determined that” or “in response to determining” or “when (a stated condition or event) is detected” or “in response to detecting (a stated condition or event)”.

All or some of the foregoing embodiments may be implemented by using software, hardware, firmware, or any combination thereof. When software is used to implement the embodiments, all or some of the embodiments may be implemented in a form of a computer program product. The computer program product includes one or more computer instructions. When the computer program instructions are loaded and executed on a computer, all or some of the procedures or the functions according to the embodiments of this disclosure are generated. The computer may be a general-purpose computer, a dedicated computer, a computer network, or another programmable apparatus. The computer instructions may be stored in a computer readable storage medium or may be transmitted from a computer readable storage medium to another computer readable storage medium. For example, the computer instructions may be transmitted from a web site, computer, server, or data center to another website, computer, server, or data center in a wired (for example, a coaxial cable, an optical fiber, or a digital subscriber line) or wireless (for example, infrared, radio, or microwave) manner. The computer readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a digital versatile disc (DVD)), a semiconductor medium (for example, a solid state disk), or the like.

For the purpose of explanation, the foregoing descriptions are provided with reference to the specific embodiments. However, the foregoing example discussions are not intended to be detailed, and are not intended to limit the embodiments precise form. According to the foregoing teaching content, many modification forms and variation forms are possible. The embodiments are selected and described to fully illustrate the principles of this disclosure and practical application of the principles, so that another person skilled in the art can make full use of this disclosure and the various embodiments that have various modifications applicable to conceived specific usage.

In the embodiments provided in this disclosure, the method provided in the embodiments of this disclosure is described from a perspective in which the terminal device is used as an execution body. To implement functions in the method provided in the embodiments of this disclosure, the terminal device may include a hardware structure and/or a software module, and implement the functions in a form of the hardware structure, the software module, or a combination of the hardware structure and the software module. Whether a function in the foregoing functions is performed by the hardware structure, the software module, or the combination of the hardware structure and the software module depends on particular applications and design constraints of the technical solutions.

1. An object recognition method, implemented by a terminal device, wherein the object recognition method comprises:
recognizing a first target object in a first frame of an image;
recognizing a second target object in a second frame of the image, wherein the second target object is adjacent to the first frame; and
determining that the first target object and the second target object are a same object when a similarity between the first target object and the second target object is greater than a preset similarity.

2. The object recognition method of claim 1, further comprising:
obtaining first feature information in the first frame;
searching a prestored object matching template for second feature information that matches the first feature information, wherein the object matching template comprises a correspondence between an object and feature information; and
determining that an object corresponding to the second feature information in the object matching template is the first target object, and
wherein the similarity is greater than the preset similarity when the first target object and the second target object belong to a same object type.

3. The object recognition method of claim 1, further comprising determining that the first target object and the second target object are the same object when the similarity is greater than the preset similarity and when a moving speed based on the first target object and the second target object is less than a preset speed.

4. The object recognition method of claim 3, wherein the moving speed is less than the preset speed when a rate of the moving speed is less than a preset rate or an included angle between a direction of the moving speed and a preset direction is less than a preset angle.

5. The object recognition method of claim 1, wherein before recognizing the first target object, the object recognition method further comprises:
detecting a user operation;
in response to the user operation, opening a camera application, starting a camera, and displaying a framing interface; and
displaying, in the framing interface, a preview image from the camera, wherein the preview image comprises the first frame and the second frame.

6. The object recognition method of claim 5, further comprising:
displaying a first control in the framing interface; and
recognizing a target object in the preview image when the first control is triggered.

7. The object recognition method of claim 1, wherein after determining that the first target object and the second target object are the same object, the object recognition method further comprises outputting prompt information, wherein the prompt information indicates that the first target object and the second target object are the same object.

8. The object recognition method of claim 1, wherein before recognizing the first target object in the first frame, the object recognition method further comprises:
displaying a chat interface of a communication application, wherein the chat interface comprises a dynamic image;
detecting an operation on the dynamic image; and
displaying a second control, wherein the second control triggers the terminal device to recognize a target object in the dynamic image.

9. The object recognition method of claim 1, wherein before recognizing the first target object, the object recognition method further comprises displaying the first frame, wherein after recognizing the first target object, the object recognition method further comprises displaying a tag of the first target object, wherein the tag comprises related information of the first target object, wherein before recognizing the second target object, the object recognition method further comprises displaying the second frame, and wherein after determining that the first target object and the second target object are the same object, the object recognition method further comprises displaying the tag in the second frame.

10. The object recognition method of claim 9, wherein after determining that the first target object and the second target object are the same object, the object recognition method further comprises changing a display location of the tag based on the first target object and the second target object.

11. The object recognition method of claim 1, wherein before recognizing the first target object, the object recognition method further comprises:
keeping the terminal device in a screen-locked state;
collecting at least two face image frames;
determining whether a first face in a first face image frame of the at least two face image frames and a second face in a second face image frame of the at least two face image frames are a same face; and
unlocking the terminal device.

12. The object recognition method of claim 1, wherein before recognizing the first target object, the object recognition method further comprises:
displaying a payment verification interface;
collecting at least two face image frame frames;
determining whether a first face in a first face image frame of the at least two face image frames and a second face in a second face image frame of the at least two face image frames are a same face; and
performing a payment procedure.

13. A terminal device, comprising:
a processor; and
a memory coupled to the processor and configured to store instructions that, when executed by the processor, cause the terminal device to be configured to:
recognize a first target object in a first frame of an image;
recognize a second target object in a second frame of the image, wherein the second target object is adjacent to the first frame; and
determine that the first target object and the second target object are a same object when a similarity between the first target object and the second target object is greater than a preset similarity.

14. The terminal device of claim 13, wherein the similarity is greater than the preset similarity when the first target object and the second target object belong to a same object type.

15. The terminal device of claim 13, wherein the instructions further cause the terminal device to be configured to determine that the first target object and the second target object are the same object when the similarity is greater than the preset similarity and when a moving speed based on the first target object and the second target object is less than a preset speed.

16. The terminal device of claim 13, wherein after the instructions cause the terminal device to determine that the first target object and the second target object are the same object, the instructions further cause the terminal device to be configured to output prompt information, wherein the prompt information indicates that the first target object and the second target object are the same object.

17. The terminal device of claim 13, wherein before the instructions cause the terminal device to recognize the first target object, the instructions further cause the terminal device to be configured to:
display a chat interface of a communication application, wherein the chat interface comprises a dynamic image;
detect an operation on the dynamic image; and
display a second control, wherein the second control triggers the terminal device to recognize a target object in the dynamic image.

18. The terminal device of claim 13, wherein before the instructions cause the terminal device to recognize the first target object, the instructions further cause the terminal device to be configured to display the first frame, wherein after the instructions cause the terminal device to recognize the first target object, the instructions further cause the terminal device to be configured to display a tag of the first target object, wherein the tag comprises related information of the first target object, wherein before the instructions cause the terminal device to recognize the second target object, the instructions further cause the terminal device to be configured to display the second frame, and wherein after the instructions cause the terminal device to determine that the first target object and the second target object are the same object, the instructions further cause the terminal device to be configured to display the tag in the second frame.

19. The terminal device of claim 18, wherein after the instructions cause the terminal device to determine that the first target object and the second target object are the same object, the instructions further cause the terminal device to be configured to change a display location of the tag based on the first target object and the second target object.

20. A computer program product comprising instructions that are stored on a computer-readable medium and that, when executed by a processor, cause a terminal device to:
recognize a first target object in a first frame of an image;
recognize a second target object in a second frame of the image, wherein the second target object is adjacent to the first frame; and
determine that the first target object and the second target object are a same object when a similarity between the first target object and the second target object is greater than a preset similarity.
